(19) United States
(12) Patent Application Publication
(10) Pub. No.: US 2004/0196410 A1
(43) Pub. Date: Oct. 7, 2004

(54) Method and apparatus for setting timing parameters for broadcast programs

(76) Inventor: Robert C. Johnson, University Park, TX (US)

Correspondence Address: HOWISON & ARNOTT, L.L.P, P.O. BOX 741715, DALLAS, TX, 75374-1715, US

(21) Appl. No.: 10/404,497

(22) Filed: Apr. 1, 2003

(51) Int. Cl. H04N 5/38

(52) U.S. Cl. 348/723

(57) ABSTRACT

System for determining segment settings for a broadcast program. A broadcast video program is received at a broadcast station location from a remote location of video programs and then recorded and stored in a program database, which recorded video program has contained therein a plurality of video segments with start and end times. A central segment timing database is accessed, the central segment timing database having pre-stored segment timing information for at least the recorded video program to define the start and end times of the video segments in at least the recorded video program. The timing information for at least the recorded video program is referenced to a common time reference point. A determination is then made if the segment timing information for at least the recorded video program is stored in the central segment timing database. If the segment timing information for at least the recorded video program is stored in the central segment timing database, then the pre-stored segment timing information for at least the recorded video program is downloaded to a local segment timing database. The start time of the first video segment in the recorded video program is determined and then the time between the start of the first video segment in the recorded video program and the common time reference stored in the local segment timing database is determined as an offset. All or a portion of the recorded video program is then broadcast utilizing the stored segment timing information and offset to the extract from the program database the video segments in the broadcast.

### TECHNICAL FIELD OF THE INVENTION

The present invention pertains in general to video broadcast systems and, more particularly, to a system for determining the start and end times of video segments within a video broadcast that are provided for determining when commercials are inserted into the program.

### BACKGROUND OF THE INVENTION

When television stations or other broadcast facilities have purchased rights to run certain syndicated shows, these programs are typically distributed by a syndicator via a satellite broadcast to the subscribing stations. Each of these broadcast stations is able to record or download and store the show for later transmission. They can also play the show to air in real-time. These syndicated shows are send to the stations with space allocated in them for the local station to insert their own commercials.

In order to determine the exact locations within the broadcast that the commercials can be inserted, it is necessary to divide the program up into “segments,” which are comprised of a start point, an end point, a duration and a sequential segment number. The syndicator will usually provide either as part of the broadcast or separately timing information that sets forth how many segments are in a program and the approximate start and end times of the segment and their duration. However, this timing information is difficult to utilize, since the timings are not generally accurate and they are not presented in a manner which can utilized by an automated system. Therefore, it is still required for some technician to actually go through the program and synchronize that program with the timing codes on the recorded program. This is due to the fact that timing information for each frame in the program does not exist until the step of recording. Thus, in order to have an accurate indication of when a segment begins and when a segment ends, a technician must actually view the entire program and then record in a table the actual start and end times for each segment.

### SUMMARY OF THE INVENTION

The present invention disclosed and claimed herein, in one aspect thereof, comprises a method for defining timing for video segments in a video broadcast program. A broadcast video program is received at a broadcast station location from a remote location of video programs and then recorded and stored in a program database, which recorded video program has contained therein a plurality of video segments with start and end times. A central segment timing database is accessed, the central segment timing database having pre-stored segment timing information for at least the recorded video program to define the start and end times of the video segments in at least the recorded video program. The timing information for at least the recorded video program is referenced to a common time reference point. A determination is then made if the segment timing information for at least the recorded video program is stored in the central segment timing database. If the segment timing information for at least the recorded video program is stored in the central segment timing database, then the pre-stored segment timing information for at least the recorded video program is downloaded to a local segment timing database. The start time of the first video segment in the recorded video program is determined and then the time between the start of the first video segment in the recorded video program and the common time reference stored in the local segment timing database is determined as an offset. All or a portion of the recorded video program is then broadcast utilizing the stored segment timing information and offset to the extract from the program database the video segments in the broadcast.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a diagrammatic view of a prior art broadcast program;

FIG. 2 illustrates a diagrammatic view of a broadcast station and its interaction with the source of the broadcast;

FIG. 3 illustrates a diagrammatic view of the extraction of timing information from the program;

FIG. 4 illustrates a table that is created for storage in the segment timing database;

FIG. 5 illustrates a diagrammatic view of assembling a broadcast program for rebroadcast;

FIG. 6 illustrates a diagrammatic view of the overall network for accessing timing information from a central database;

FIG. 7 illustrates a flow chart for the operation of creating the timing information;

FIG. 8 illustrates a diagrammatic view of a system that utilizes universal IDs;

FIG. 9 illustrates an alternate embodiment utilizing a distributed network;

FIG. 10 illustrates a flow chart for accessing the UID associated information;

FIG. 11 illustrates the use of the timing information with respect to rejecting commercials; and

FIG. 12 illustrates a flow chart depicting an alternate embodiment wherein commercials are replaced.

### DETAILED DESCRIPTION OF THE INVENTION

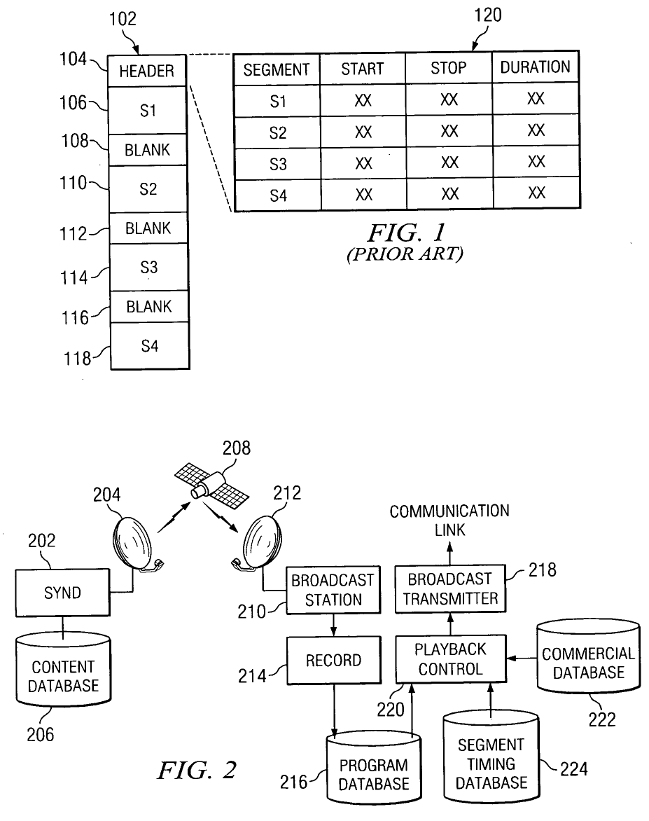

Referring now to FIG. 1, there is illustrated a diagrammatic view of a prior art system for determining the start and stop times for various segments in a broadcast program. There is illustrated a program 102 that is comprised of a header 104 that occurs at the beginning of the program. This can be a graphics that is provided to a broadcast station in a single frame or multiple frames. This is followed by a broadcast of a first segment 106—at the end of the segment 106, there being provided a blank programming segment 108. This will be followed by the transmission of a second segment 110, followed by a blank transmission portion 112, followed by a third segment 114, that followed by a third blank programming section 116, that followed by a final fourth segment 118. Thus, it can be seen that there are four video segments in a broadcast program, this being very typical for a half hour video program. Typically, during the body of the program, there will be provided at least two commercial areas, these provided by the blank video portions 108 and 112. At the end of the third segment 114, this being substantially the entire program, there will be provided a third commercial portion in the blank section 116, followed by the fourth segment 118 which is typically an epilog. Since the original programming information is set to fit within a particular time slot from beginning to end, it is only necessary to know where the blank portions are in order to insert commercials therein. When rebroadcasting the program, the program is typically initiated and, at the end point of each segment, the transmission switched over to a commercial and, just at or after the beginning of the next segment, the programming is switched back over to the continuously running program such that there might be some overlap, which is not a problem, as either the commercial is cut short or a portion of the beginning of a video segment is not broadcast. Additionally, for the purpose of switching from commercials back to the program, there may be a “leader” portion at the beginning of a particular video segment that is a countdown portion that allows the programmer to know when to switch back to the program which may actually result in prematurely terminating a commercial.

Typically, the header 104 which maybe provided by the syndicator or the source of the broadcast will have information in the form of, for example, a table 120 provided. This will provide the number of segments and, for each segment, the start position, stop position, and duration thereof. This information may be provided in a separate paper document also.

Referring now to FIG. 2, there is illustrated a diagrammatic view of the overall system for transmitting a broadcast program from a source to a broadcast station. There is provided a syndicator location 202 that has a satellite dish 204 associated therewith for communicating with a satellite 208. The syndicator has associated therewith a content database 206, which content database 206 contains the various programming information. The syndicator 202 determines the time that the content is to be broadcast and on which channel it is to be broadcast. This information is typically relayed to various broadcast stations and interested parties via another method, such as a programming schedule. A broadcast station 210, there only being one illustrated, is provided that also has a satellite dish 212 associated therewith for receiving broadcast information from the satellite 208 on a particular channel at any particular time. The broadcast station 210 receives this information with no control thereover, i.e., it receives exactly what was transmitted during the time it was transmitted. This information is recorded, as indicated by a block 214 which recording operation is operable to store the information in a program database 216, which is a local database to the broadcast station 210. The broadcast station 210 is authorized to receive and record this information and later broadcast it.

During the broadcast operation, the broadcast station 210 will have a broadcast transmitter 218 associated therewith that is connected to a communication link. There is provided a play back control system 220 that is operable to extract the program out of the program database 216 and insert commercials therein from a commercial database 222. The play back control system 220 also has access to a segment timing database 224 that is operable to store the various timing information for the segments in the program that is extracted from the program database 216. The storage of the segments will be described hereinbelow. With the use of the knowledge from the segment timing database 224 as to when the segments in a particular program might begin and end, it is possible to insert the appropriate commercials therein. Typically, prior to playing back the program, the entire program has a “timing script” that is preassembled such that the playback control 220 merely accesses particular segments from the program database 216 and the commercial database 222. Additionally, it should be understood that the program database 216 could be a program that has analog programs contained therein which is initiated at a particular time and run for the entire duration of the program and the commercials merely inserted into the broadcast by switching between the program that is being extracted from the program database 216 and the commercials that are extracted from the commercial database 222.

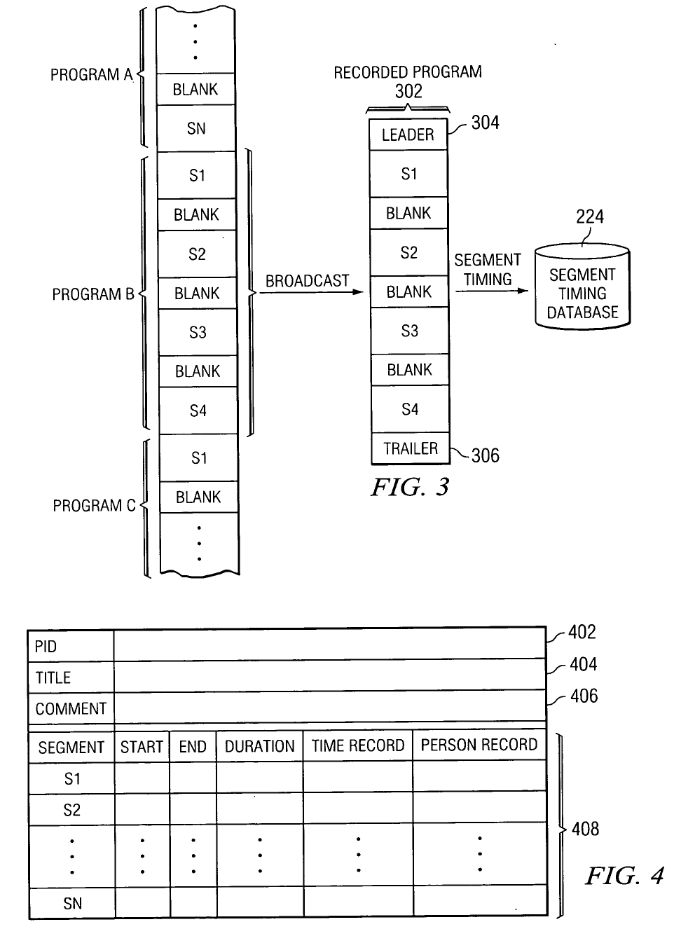

Referring now to FIG. 3, there is illustrated a diagrammatic view for the overall extraction of the segment timing associated with the information stored in the segment timing database 224. The program information from a syndicator is typically comprised of multiple broadcast programs that are transmitted in a streaming manner. For example, it may be at the “top of the hour” that a particular program is initiated. However, prior to the initiation of this program, there could have been another program that preceded it and, a program that will actually follow the program that was transmitted at the top of the hour after the full duration thereof. Further, when recording the programming, it can be that the program is initially transmitted with actual commercial content during prime time which, when recorded by the broadcast station, is recorded for later playback or delayed playback. Typically, a broadcast station will not need or desire to receive all programming from the syndicator and they only want to receive a single program.

In the example illustrated in FIG. 3, there are illustrated three sequential programs, program A, program B and program C, that are transmitted by the source or syndicator. The program B is the only program that the broadcast station desires to record. Thus, it can be seen in the example illustrated in FIG. 3, that there are four transmitted segments, S1, S2, S3 and S4 in program B with three blank regions separating the four segments. This program will be recorded as a program 302. However, the start time and end time for the actual recording of the entire program B may actually be longer than the original program from the source or syndicator, to ensure that the entire program is received. Thus, there will result a potential leader portion 304 that will precede segment S1 and a potential trailer segment 306 that will follow segment S4. It is the existence of this leader section 304 that can cause some problems in synchronizing the start and end times of the various blank regions for the purpose of inserting commercials. Therefore, the segment timing is extracted, as will be described hereinbelow, and stored in the segment timing database 224.

Referring now to FIG. 4, there is illustrated a diagrammatic view of a table which contains all the information associated with a particular program regarding the segment timing and other information associated therewith. The table of FIG. 4 can have any organization and can include the information as illustrated in FIG. 4 or additional information, or even less information. In the example of FIG. 4, the table includes a program ID (PID) in a field 402, a title in a field 404 and a comment section in a field 406. When the segment timings are determined for a particular program, a PID is assigned to the particular program, in addition to a title. For example, if a sports program or broadcast related to a car race, the technician could name this as “CARRACEABC” or it could be “CARRACE-MONDAY” depending upon what the technician wants to name the program or the convention associated therewith. As another example, consider a syndicated show that is aired every day and the technician might put the program name followed by the day of the week. In any event, the title is fairly subjective, as the syndicator has no control over this naming procedure. The comment in field 406 is merely a comment added by the technician which has little or no significance and is for reference purposes only. A next section 408 is provided for containing the information regarding each of the segments. There will typically be provided a number of segments that are contained within the program in addition to possibly the start time, the end time, the duration of the segment, the time that the segment information was recorded and the person recording that information. It should be understood that timing is relative to frames. The program is transmitted in frames which have a defined timing arrangement, i.e., there are a defined number of frames per second. Therefore, start times typically refer to the time of a start frame and the end time typically refers to the time of the frame number at the end point of a segment, each frame having a time stamp associated therewith. The duration will typically be referred to in the number of frames. Once all of this information is obtained by the technician, it can be stored in a table and the table stored in the database 224. With respect to the PID, this is defined in accordance with some type of identification or protocol that is standardized industry wide whereas the title can be very subjective.

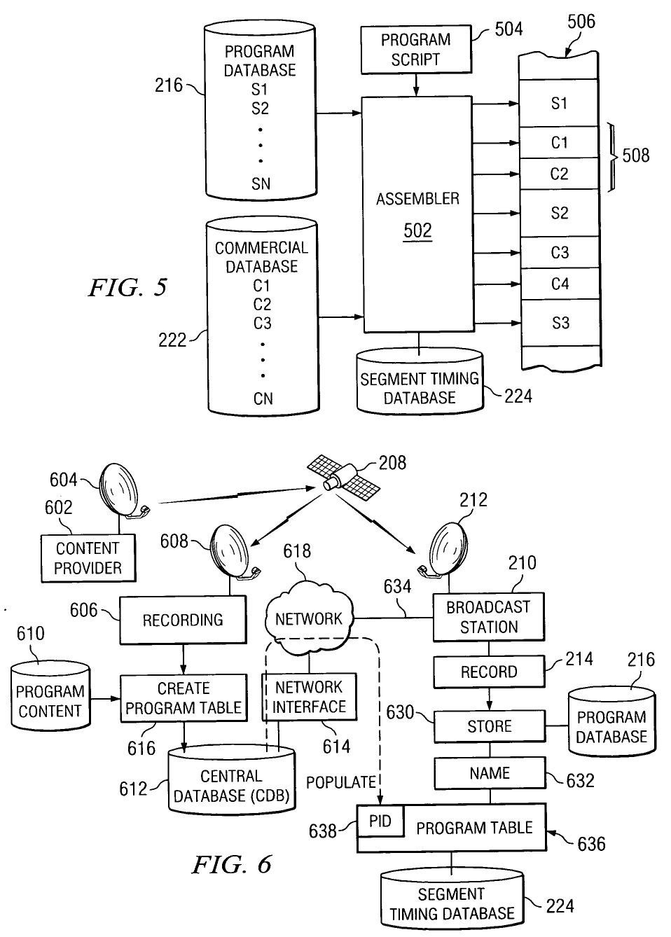

Referring now to FIG. 5, there is illustrated a diagrammatic view of how the segment timing database 224 is utilized to assemble a program related broadcast or for a real time broadcast. Information in the programming database concerning the various segments comprises the content of the program. This can be a digital database wherein each segment is digitized and stored as a single segment, i.e., the area between an adjacent segment during the initial program is removed, or the entire broadcast program as received can be stored as a whole. Alternatively, the entire program as received can be stored as an analog program, in a database of analog video recordings, such as a VCR. The commercial database 222 contains commercials, as either digitized video segments or analog video segments, which are each essentially separate video programs with a start and an end time. A program assembler 502 is operable to utilize the program script 504 for the purpose of extracting information from the program database 216 and information from the commercial database 222 for the purpose of outputting it to a broadcast program 506. The program script 504 comprises the list of what is to be transmitted. For example, the script will define the location in the commercial database 216 segment S1 for a particular program. This segment S1 is extracted and then, utilizing the information in the segment timing database 224, at the end of segment S1, commercials C1 and C2, for example, in a commercial field 508, are extracted from commercial database 222 and inserted between S1 and S2. At the end of the commercial C2 in the commercial region 508, the assembler 502, in accordance with the program script 504, will extract the next segment S2 out of the program database 216. Additionally, the assembler 502 could be operated in a mode where the program database selects a program, which program is comprised of segments S1-S3 with two blank regions disposed therein between segments S1 and S2 and between segments S2 and S3, respectively. The program is then initiated at the beginning of segment S1 and then is continuously output after initiation thereof. However, the assembler 502 is operable to switch between the program running from program database 516 and commercials extracted from the commercial database 222. It should be understood that the program database 216 media could be an optical disc, a VCR or a hard disc drive. It is any source of content information that has timing information associated therewith, i.e., each frame can be discriminated. It is only important for introducing commercials that there be some start time that indicates when the first segment has been initiated.

Referring now to FIG. 6, there is illustrated a diagrammatic view of the network for accessing segment timing information from a central database. In this embodiment, segment timing information is derived by recording programs from the satellite 208, as described hereinabove, which are broadcast by a content provider 602 via a satellite dish 604. The information is received by any of the receiving systems, the broadcast station 212 or a separate central recording station 606 that has a satellite dish 608 associated therewith for receiving content from a content provider 602. The recording station 606 is a centralized station that has the primary purpose of recording the information and generating the segment timing database. An operative block 608 illustrates that the recording is received and stored in a database 610 and then the programming information extracted therefrom with a technician, as described hereinabove. This timing information is stored in a central database 612, which is available to other users via a network interface 614 that interfaces with the network 618, which network 618 can be a Global Communication Network (GCN), a Local Area Network (LAN) or the such.

The broadcast station 210, as described hereinabove, is operable to receive a recording of interest which is then recorded in the block 214 for storage in the program database 216 via a storage block 630. Another block 632 is provided that defines the manual operation wherein a technician actually examines the program and then associates some type of name with the program. This could be a PID and a title. However, it is noted that the title can be relatively subjective, as described hereinabove. However, once the program is received and named, the technician must then decide whether to go through and review the entire program to set the segment timing marks. Prior to doing this, however, a technician can access the central database 612 via the network 618 with a network interface 634. The purpose of this is to obtain a listing of the programs associated therewith, the ability to search the database names, etc., in order to determine whether a segment timing table has been previously generated, which information could be utilized to generate a program table 636 that is local to the broadcast station 210 and which will be stored in the segment timing database 224. The technician will typically, in this embodiment, define a PID in a field 638 for a program and then, before settling on a name, search the central database 612. If the program that is being reviewed by the technician is associated with the program having a pre-stored segment timing table stored in the central database 612, then this information is downloaded for the purpose of populating the program table 636. Typically, the program table 636 will be identical to that associated with the one in the central database 612; however, the information could be downloaded and inserted into various fields by other techniques well known in the art.

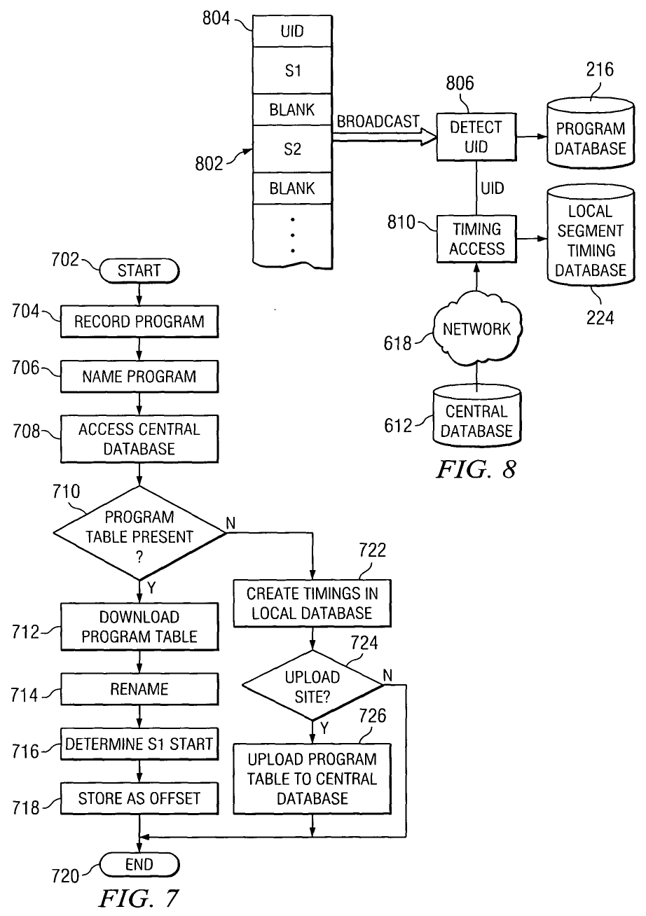

Referring now to FIG. 7, there is illustrated a flow chart for the operation of the system in FIG. 6. This is initiated at a block 702 and then proceeds to a block 704 wherein the program is recorded. In this mode, the program is downloaded at a preset time from the syndicator or source. This is merely an operation wherein a record operation is started at the preset time. This may actually be before the actual program is initiated and it may terminate after the program has finished. The program then proceeds to a function block 706 to name the program, this being a name that the technician will assign to the program. The program then flows to a function block 708 to access the central database for the purpose of determining if segment timing settings are stored thereat. This access can be in conjunction with the record operation or it can be done at a later time. The program then flows to a decision block 710 to determine if a program table of timing settings is present for the segment timing settings. If so, the program will flow along a “Y” path to a function block 712 to download the program table and then to a function block 714 to rename the program, this name being the one that was associated with the downloaded program table. In this manner, there can be a level of consistency maintained. The program then flows to a function block 716 to determine the start time of the first segment. This is done by the technician and is utilized to determine the offset between the actual recorded program and the S1 start time, this being a reference. This offset is then stored in a table as an offset, as indicated by a function block 718. The program then flows to an END block 720. This offset, as described hereinabove, is an offset that will be applied to each of the segment times such that they are offset from the beginning or first frame of the recording as recorded at the local broadcast station, which first frame of the recording may not be the first frame of the first segment of the broadcast program.

If, during access of the central database, it was determined that the program table was not present, the program would flow from decision block 710 along a “N” path to a function block 722 to create timings in the local segment timing database. This, as described hereinabove, is a manual operation wherein a technician must review the entire program. The program then flows to a decision block 724 to determine if the broadcast station is an upload site. This is a site that is authorized to create segment timing tables. If so, the program flows along the “Y” path to a function block 726 to upload the program table to the central database and then to the END block 720. If the site was determined not to be an upload site, the program would bypass the function block 726 along the “N” path from decision block 724 and flow directly to the END block 720.

Referring now to FIG. 8, there is illustrated a diagrammatic view of an alternate embodiment of the present invention. In this embodiment, a program 802 is provided which has associated therewith a UID field 804, this containing a UID that uniquely identifies the program for automatic detection and operation thereon. In this mode, the first step after receiving the broadcast is to perform a detection to determine if a UID is present, as indicated by block 806. If the UID is present, it is utilized in a timing access block 810 to actually initiate access with the central database 612 via the network 618 to determine if a corresponding program to that associated with a UID in field 804 exists within database 612. If so, then the timing access block 810 will access the segment timing information and store it in the local segment timing database 224 associated with the broadcast station. By providing the UID, the access of the timing information can be automatic and does not necessarily require the step of naming the program and then doing a look up for a similarly named program in the central database 612. Without the UID, the technician would have to recognize how the original program was evaluated and named by the technician that created the central database 612. Since there are two individuals that are creating these names, there can be some disparity there between. With the use of the UID, this disparity is removed.

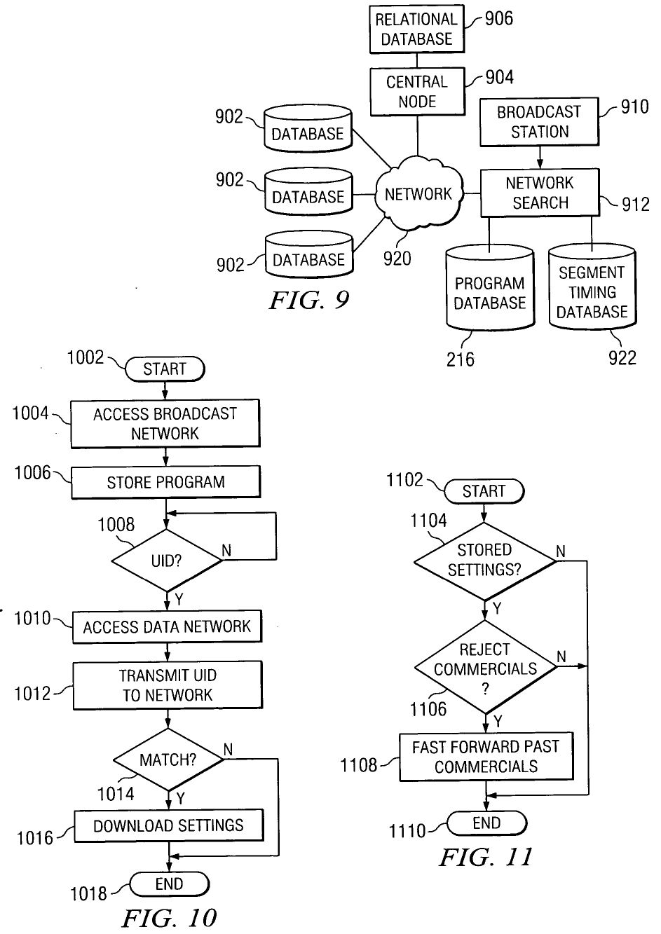

Referring now to FIG. 9, there is illustrated a diagrammatic view of an alternate embodiment wherein the central database 612 is distributed among multiple distributed databases 902. Each of these databases can contain information as to the segment timing and some of this can be duplicated. A central node 904 can be provided, which central node 904 can access a relational database 906 that has a table stored therein that defines the addresses of the remote nodes 902 that have the information stored therein. Further, the central node 904 need not be used and a search of the network and information on each of the distributed databases can be performed utilizing conventional Internet search engines. Thus, a broadcast station 910 having a network searching functionality 912 associated therewith can access the nodes through a network 920 and the central node 904 to store the segment timing information in a segment timing database 922.

Referring now to FIG. 10, there is illustrated a flow chart for the operation utilizing a UID. This is initiated at a block 1002 and then proceeds to a function block 1004 to access the broadcast network and then record and store the program, as indicated in a function block 1006, and then proceed to a decision block 1008 to determine if a UID was present in the broadcast. This UID, as described hereinabove, can be disposed in a header or it can actually be embedded within the program itself in a hidden manner. For example, it could be in the vertical blanking interval (VBI) of the program, a conventional place to store conventional data. This will allow the data to be transmitted during the program download. Of course, there could be other methods utilized, and even a method utilized wherein the UID was transmitted within the audio/video bandwidth of the program. The program then proceeds to a function block 1010 to access the data network and then to a function block 1012 in order to transmit the UID to the network and the central database. The program then flows to a decision block 1014 to determine at the central database if a match has been determined. If so, the settings are downloaded, as indicated by a function block 1016. The program then flows to an END block 1018. If there was no match, then the program would flow to the END block 1018 directly from the decision block 1014 and then the technician would have to proceed as described hereinabove.

Referring now to FIG. 11, there is illustrated a function block depicting the operation wherein a particular program, when recognized, can have the segment timing “settings” utilized for the purpose of eliminating commercials. The program is initiated at a block 1102 and then proceeds to a decision block 1104 to determine if stored settings exist for either program that is being operated. Although not illustrated in this example, if storage settings were not stored, it is possible to utilize information to go to the network and access these storage settings. This was described hereinabove. If storage settings are present, the program would flow along a “Y” path to a decision block 1106 to determine if the user has selected the option to reject commercials. If so, the program will flow along a “Y” path to a function block 1108 to fast forward commercials. This application is directed toward the application where programming can be stored in real time and then played back at a later time, this storage being in a digital format. These are typically referred to as Personal Video Recorders (PVR). These are utilized to record programming on a digital media and then viewed at a later time. With the use of knowledge of the start and end times for these segments, it is then possible to reject the commercials, it being noted that the user must synchronize the timing settings to the beginning of the program. This would require the user, when desiring to fast forward commercials, to determine when the program was initiated. However, it is possible that the UID could indicate the first frame of the program, this being the start time of the first segment. Once all the fast forwarding of the commercials is performed, the program will flow to an END block 1110.

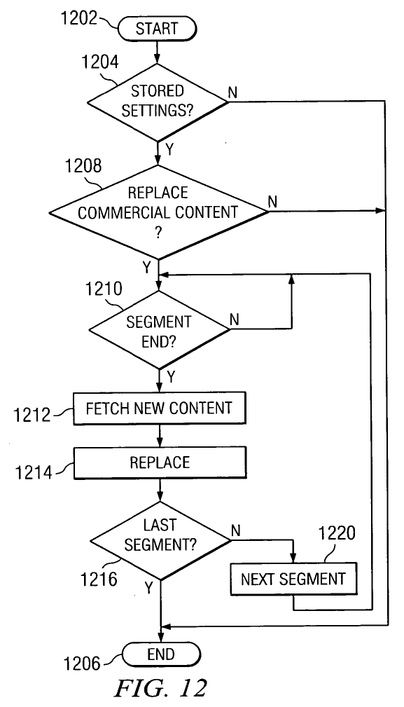

Referring now to FIG. 12, there is illustrated a flow chart depicting the operation of actually replacing commercial content with other content during playing of a program. This is initiated at a block 1202 and then the program flows to a decision block 1204 to determine if stored segment timing settings are available. If not, the program flows along an “N” path to an END block 1206. If stored settings exist, the program will flow to a decision block 1206 to determine if the user or the control of the broadcast has indicated that commercial content should be replaced with different commercials. (As noted hereinabove, if the stored settings are not stored, then they can be accessed.) If not, the program flows along an “N” path to the END block 1206 The program then flows from the decision block 1208 when commercial content is determined to be required to be replaced and to a decision block 1210. This is block 1210 determines if a segment end has occurred. If not, the program will loop back to the input of decision block 1210 until the end of the segment has occurred. After this, the program will flow along a “Y” path to a function block 1212 in order to fetch the new content, i.e., the information that is to replace the commercial. This is then replaced, as indicated by a function block 1214 and then the program proceeds to a decision block 1216 to determine if this is the last segment. If so, the program flows along a “Y” path to the END block 1206 and, if not, the program flows along an “N” path to a function block 1220 to select the next segment timing information and then proceeds to the input of decision block 1210.

Although the preferred embodiment has been described in detail, it should be understood that various changes, substitutions and alterations can be made therein without departing from the spirit and scope of the invention as defined by the appended claims.

What is claimed is:

1. A method for defining timing for video segments in a video broadcast program, comprising the steps of:
recording at a broadcast station location a broadcast video program from a remote location of video programs and storing the recorded video program in a program database, which recorded video program has contained therein a plurality of video segments with start and end times;
accessing a central segment timing database having pre-stored segment timing information for at least the recorded video program to define the start and end times of the video segments in at least the recorded video program, the timing information for at least the recorded video program referenced to a common time reference point;
determining if the segment timing information for at least the recorded video program is stored in the central segment timing database;
if the segment timing information for at least the recorded video program is stored in the central segment timing database, then downloading the pre-stored segment timing information for at least the recorded video program to a local segment timing database;
determining from the recorded video program the start time of the first video segment therein;
determining as an offset the time between the determined start of the first video segment in the recorded video program and the common time reference stored in the local segment timing database; and
broadcasting all or a portion of the recorded video program utilizing the stored segment timing information and offset to the extract from the program database the video segments in the broadcast.

2. The method of claim 1, and further comprising the steps of inserting video content extracted from a content database into the recorded video program when broadcast at a select time position therein.

3. The method of claim 2, wherein the select time position is between select video segments in the all or a portion of the recorded video program that is broadcast.

4. The method of claim 2, wherein the inserted content comprises commercial information.

5. The method of claim 1, wherein the central segment timing database is disposed at a remote location from the broadcast station location.

6. The method of claim 5, wherein the step of accessing the remote location comprises connecting to the remote location over a network and accessing the central segment timing database thereover.

7. The method of claim 5, wherein the step of accessing is in response to the step of recording.

8. The method of claim 1, wherein the step of determining the start time of the first video segment in the recorded program is a manual operation.

9. The method of claim 1, wherein the central segment timing database contains segment timing information for a plurality of broadcast video programs.

10. The method of claim 9, wherein the step of determining if the segment timing information for at least the recorded video program is stored in the central segment timing database comprises the step of storing title information in the central segment timing database for each of the plurality of broadcast video programs having segment timing information stored in the central segment timing database and accessing the title information and comparing information known about the recorded video program with the accessed title information to determine if the segment timing information for at least the recorded video program is stored in the central segment timing database.

11. A method for defining timing for video segments in a video broadcast program, comprising the steps of:
recording at a broadcast station location a broadcast video program from a remote location of video programs and storing the recorded video program in a program database, which recorded video program has contained therein a plurality of video segments with start and end times and a unique ID (UID);
accessing a central segment timing database having pre-stored segment timing information for at least the recorded video program in association with a UID to define the start and end times of the video segments in at least the recorded video program, the timing information for at least the recorded video program referenced to a common time reference point;
determining if the segment timing information for at least the recorded video program is stored in the central segment timing database by comparing the received UID to the UID stored in the central segment timing database;
if the UID for at least the recorded video program is stored in the central segment timing database, then downloading the pre-stored segment timing information for at least the recorded video program to a local segment timing database;
determining from the recorded video program the start time of the first video segment therein;
determining as an offset the time between the determined start of the first video segment in the recorded video program and the common time reference stored in the local segment timing database; and
broadcasting all or a portion of the recorded video program utilizing the stored segment timing information and offset to the extract from the program database the video segments in the broadcast.

12. The method of claim 11, and further comprising the steps of inserting video content extracted from a content database into the recorded video program when broadcast at a select time position therein.

13. The method of claim 12, wherein the select time position is between select video segments in the all or a portion of the recorded video program that is broadcast.

14. The method of claim 12, wherein the inserted content comprises commercial information.

15. The method of claim 11, wherein the central segment timing database is disposed at a remote location from the broadcast station location.

16. The method of claim 15, wherein the step of accessing the remote location comprises connecting to the remote location over a network and accessing the central segment timing database thereover.

17. The method of claim 15, wherein the step of accessing is in response to the step of recording.

18. The method of claim 11, wherein the step of determining the start time of the first video segment in the recorded program is a manual operation.

19. The method of claim 11, wherein the central segment timing database contains segment timing information for a plurality of broadcast video programs.

20. The method of claim 19, wherein the step of determining if the segment timing information for at least the recorded video program is stored in the central segment timing database comprises the step of storing title information in the central segment timing database for each of the plurality of broadcast video programs having segment timing information stored in the central segment timing database and accessing the title information and comparing information known about the recorded video program with the accessed title information to determine if the segment timing information for at least the recorded video program is stored in the central segment timing database.
